(19) United States
(12) Patent Application Publication
(10) Pub. No.: US 2026/0343493 A1
(43) Pub. Date: Oct. 29, 2026

(54) DYNAMIC BANDWIDTH EXPANSION WITH CHANNEL SWITCHING

(71) Applicant: Cisco Technology, Inc., San Jose, CA (US)

(72) Inventors: Brian D. Hart, Sunnyvale, CA (US); Binita Gupta, San Diego, CA (US); Malcolm Muir Smith, Richardson, TX (US)

(73) Assignee: Cisco Technology, Inc., San Jose, CA (US)

(21) Appl. No.: 19/715,993

(22) Filed: Jun. 22, 2026

Related U.S. Application Data
(63) Continuation of application No. 19/631,718, filed on Mar. 27, 2026.
(60) Provisional application No. 63/780,283, filed on Mar. 29, 2025.

(51) Int. Cl. H04W 72/04

(52) U.S. Cl. CPC H04W 72/04

(57) ABSTRACT

Dynamic bandwidth expansion (DBE) with channel switching may be provided. Managing DBE with channel switching includes operating, by an access point (AP), at a baseline operating bandwidth. The AP expands from the baseline operating bandwidth to an expanded operating bandwidth for a client device associated with the AP. When the AP determines to switch from a first channel to a second channel, the AP reverts to the baseline operating bandwidth and switches from the first channel to the second channel.

### RELATED APPLICATION

This application is a continuation of U.S. Pat. Appl. Ser. No. 19/631,718, filed Mar. 27, 2026, which claims the benefit of and priority under provisions of 35 U.S.C. § 119(e) to U.S. Prov. Appl. No. 63/780,283, filed Mar. 29, 2025, the disclosure of which is incorporated herein by reference in its entirety.

### TECHNICAL FIELD

The present disclosure relates generally to providing dynamic bandwidth expansion with channel switching.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for managing dynamic bandwidth expansion (DBE) with channel switching in accordance with aspects of the present disclosure.

FIG. 2 illustrates a timing graph of an access point (AP) resetting DBE at the same time or before channel switching in accordance with aspects of the present disclosure.

FIG. 3 illustrates a timing graph of an AP continuing DBE during channel switching in accordance with aspects of the present disclosure.

FIG. 4 illustrates a beacon frame for signaling continuing DBE during channel switching in accordance with aspects of the present disclosure.

FIG. 5 illustrates a channel switch announcement frame for signaling continuing DBE during channel switching in accordance with aspects of the present disclosure.

FIG. 6 illustrates a timing graph of an AP resetting DBE without signaling a switch during channel switching in accordance with aspects of the present disclosure.

FIG. 7 is a flow diagram illustrating a method for managing DBE with channel switching in accordance with aspects of the present disclosure.

FIG. 8 is a block diagram of a computing device in accordance with aspects of the present disclosure.

FIG. 9 is a block diagram of a communications device in accordance with aspects of the present disclosure.

### DETAILED DESCRIPTION

### Overview

Dynamic bandwidth expansion (DBE) with channel switching may be provided. Managing DBE with channel switching includes operating, by an access point (AP), at a baseline operating bandwidth. The AP expands from the baseline operating bandwidth to an expanded operating bandwidth for a client device associated with the AP. When the AP determines to switch from a first channel to a second channel, the AP reverts to the baseline operating bandwidth and switches from the first channel to the second channel.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bn wireless networking amendment (and being marketed and certified by the Wi-Fi Alliance as Wi-Fi 8) defines a Dynamic Bandwidth Expansion (DBE) feature, and DBE is currently being developed. DBE is a mode of operation that allows an Ultra-High Reliability (UHR) Access Point (AP) to widen the bandwidth (BW) of its Basic Service Set (BSS) for modern clients (e.g., UHR stations or Wi-Fi 8 clients) without disrupting legacy clients. The DBE operation enables a UHR AP to dynamically modify (e.g., expand, change, or reset) its operating BW for UHR STAs that support DBE operation. When resetting the operating bandwidth, the AP reverts back to the baseline BW. When operating in DBE mode with an expanded BW, the UHR AP continues to serve STAs that do not support DBE operation within the baseline, narrower BW.

DBE can be utilized to manage the load of APs in dense deployment scenarios. For example, in a network with four neighboring APs each operating on different 40 MHz channels, three APs may have a relatively light load while one AP is more heavily loaded. The more heavily loaded AP can perform DBE to expand to a wider BW (e.g., 80 MHz, 160 MHz, 360 MHz, etc.) to manage the higher load while creating minimal disruption to the other APs and their respective BSSs.

An AP can announce a dynamic BW change (expand, change, or reset) using a BSS parameters critical update mechanism in management frames, including beacon, probe response, and (Re)association response frames. The dynamic BW change includes enabling DBE mode itself with an expanded DBE BW (e.g., expanding from the baseline BW of 40 MHz to 160 MHz DBE BW), and the AP may later update the DBE BW to a different value (e.g., changing from 160 MHz DBE BW to 320 MHz DBE BW). The AP can also disable DBE mode, which can be considered as resetting the DBE BW to the baseline BSS BW. The dynamic BW change is typically announced for multiple beacon intervals in advance before the BW change takes effect. After a dynamic BW change, the AP may continue operating with the updated DBE BW until a subsequent BW change occurs. While an AP is operating in DBE mode, any expanded operating BW will be greater than the baseline BSS BW.

DBE can be deployed in the 6 GHz spectrum, including Standard Power operation on Unlicensed National Information Infrastructure (U-NII) sub-bands 5 and 7, and in the 5 GHz Dynamic Frequency Selection (DFS) spectrum. Standard Power operation enables higher transmit power for devices that know their geographic location and communicate with an Automated Frequency Coordination (AFC) database to determine the maximum power they can use on channels without interfering with licensed incumbents (e.g., satellite services, radar systems, utility microwave links, or other existing licensed users). In these regulatory environments, the reporting or detection of an incumbent, especially if on the primary channel or even within the unwidened, baseline BSS BW, can lead to a sudden change of the channel from usable to unusable, creating an urgent need to switch the channel of the BSS to a different channel. Channel switching is the process of an AP changing its operating frequency to a less congested or usable channel to avoid an unusable channel, improve speed, reduce interference, increase stability, or the like. The urgency of channel switching is particularly acute with DFS spectrum due to stringent regulatory rules on vacating a channel once an incumbent is detected. The urgency with AFC spectrum is comparatively lower.

In other instances, Radio Resource Management (RRM) considerations related to non-Wi-Fi and Wi-Fi interference (e.g., persistent interference from unlicensed cellular systems or other poorly behaved transmitters) might make changing channels advisable. In these scenarios, the urgency is typically markedly lower, and the AP has more time to gracefully manage DBE operation, whether that includes reverting to the baseline BW or otherwise, before transitioning to a new channel.

The present disclosure addresses the management of DBE operation during channel switching events, including both critically urgent scenarios (e.g., DFS incumbent detection) and non-urgent scenarios (e.g., RRM optimization). Various embodiments are disclosed that define how an AP handles the widened DBE BW when performing a channel switch, including resetting DBE before switching, continuing DBE operation to the new channel with preserved or modified BW parameters, and implementing automatic rules or signaled policies for DBE session management during channel transitions.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

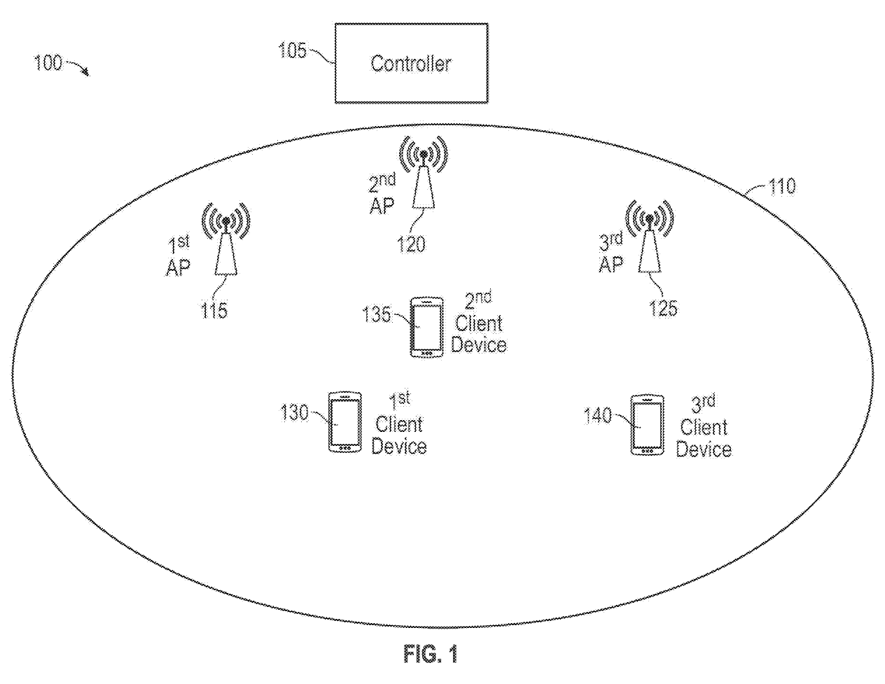

FIG. 1 shows an operating environment 100 for managing DBE operation with channel switching. As shown in FIG. 1, operating environment 100 comprises a controller 105 and a coverage environment 110. Coverage environment 110 comprises a Wireless Local Area Network (WLAN) comprising a plurality of Access Points (APs) that provide wireless network access for client devices. The APs comprise a first AP 115, a second AP 120, and a third AP 125 in the illustrated embodiment. As described below, the plurality of APs can comprise any number of APs in further embodiments.

The APs provide wireless network access to client devices (i.e., Stations (STAs)) as they move within coverage environment 110. The client devices comprise a first client device 130, a second client device 135, and a third client device 140. The client devices may be any device that can wirelessly connect to the network, such as a smart phone, a personal computer, a tablet device, a mobile device, a telephone, a remote control device, a set-top box, a digital video recorder, an Internet-of-Things (IoT) device, a network computer, a router, a Virtual Reality (VR)/Augmented Reality (AR) device, or other similar microcomputer-based device. Each of the plurality of APs may be compatible with specification standards such as the IEEE 802.11 specification standard, including the IEEE 802.11bn (Wi-Fi 8) standard that supports DBE operation.

The APs and the client devices may use Multi Link Operation (MLO) where they simultaneously transmit and receive across different bands (or links) and channels by establishing two or more links to two or more AP radios in certain embodiments. These bands may comprise the 2.4 GHz band, the 5 GHz band, the 6 GHz band, and the 60 GHz band. The two or more links on any given one of the plurality of client devices may be made with any one AP or with any combination of the APs.

Controller 105 comprises a WLAN controller which might be a physical device, software running on a computer, a logical function running on an AP, a logical function running in the cloud, and/or a logical function split across two or more of these entities. This WLAN controller may provision and control coverage environment 110 (e.g., the WLAN). Controller 105 may allow first client device 130, second client device 135, and third client device 140 to join coverage environment 110. In some embodiments, controller 105 may be implemented by a Digital Network Architecture Center (DNAC) controller (i.e., a Software-Defined Network (SDN) controller) that configures information for coverage environment 110 to facilitate DBE operation and channel switching management. In some embodiments, controller 105 or another component in operating environment 100 may include a Radio Resource Management (RRM) function that configures information for coverage environment 110 to optimize wireless performance, including managing DBE operation and channel switching decisions.

Each of the APs (e.g., first AP 115, second AP 120, third AP 125) is capable of performing DBE operation and channel switching. For DBE operation, an AP can dynamically widen its BW to an expanded DBE BW for client devices that support DBE (e.g., UHR STAs or Wi-Fi 8 clients) while continuing to serve legacy client devices on the baseline BW. For example, an AP operating on a baseline BW of 40 MHz may expand to a 160 MHz or 320 MHz DBE BW when managing higher traffic loads and/or when other neighboring APs are lightly loaded.

For channel switching, each AP can change its operating frequency to a different channel in response to various triggering events. These triggering events may include detecting incumbents (e.g., radar detection in 5 GHz DFS spectrum), receiving updated power allocation from an AFC database for 6 GHz Standard Power operation, encountering persistent non-Wi-Fi interference (e.g., unlicensed cellular systems), or implementing RRM optimizations to reduce Wi-Fi interference and improve overall network performance. Channel switching urgency varies depending on the triggering event. For example, DFS incumbent detection requires rapid channel vacation due to stringent regulatory requirements while RRM-driven channel changes typically allow more lead time for graceful transition.

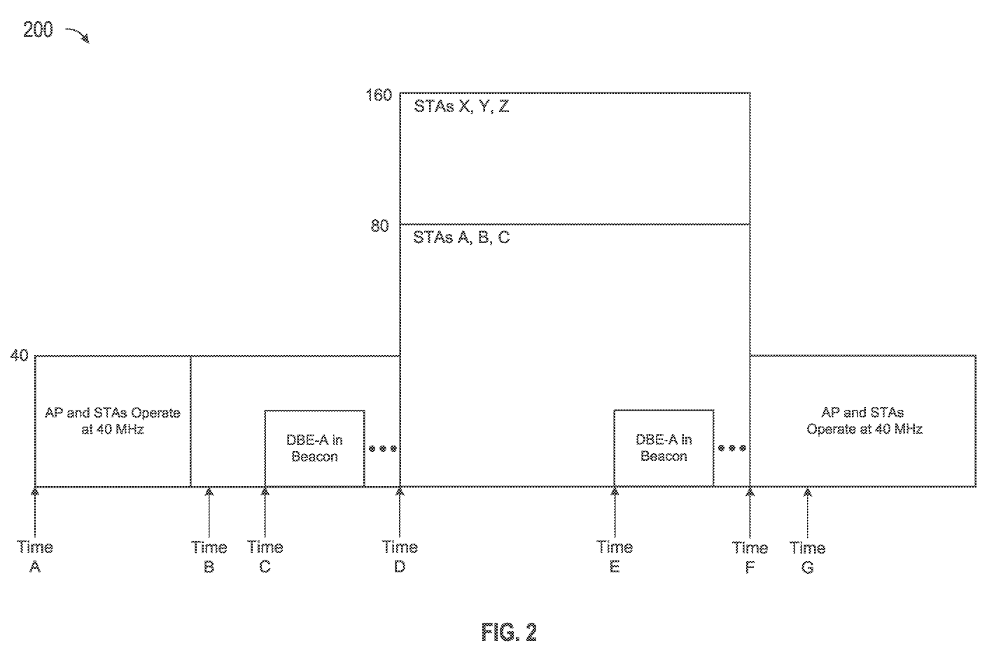

The APs are further configured to manage the interaction between DBE operation and channel switching according to various techniques disclosed herein. When a channel switch is required, an AP (with or without interaction with the controller 105) must determine how to handle the expanded DBE BW during the transition to the new channel. This determination may involve resetting DBE mode before performing the channel switch, continuing DBE operation to the new channel with preserved or modified BW parameters, automatically tearing down DBE sessions upon channel switch based on defined rules or signaled policies, or adjusting DBE BW based on the regulatory and spectral characteristics of the new channel. The specific technique employed may depend on factors such as the urgency of the channel switch, the amount of advance notice available, the characteristics of the target channel, and applicable regulatory requirements for the new channel. Additional details regarding these techniques are described with respect to FIGS. 2-6.

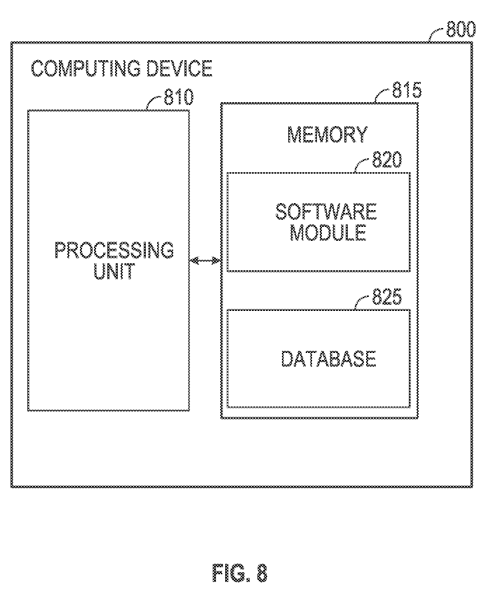

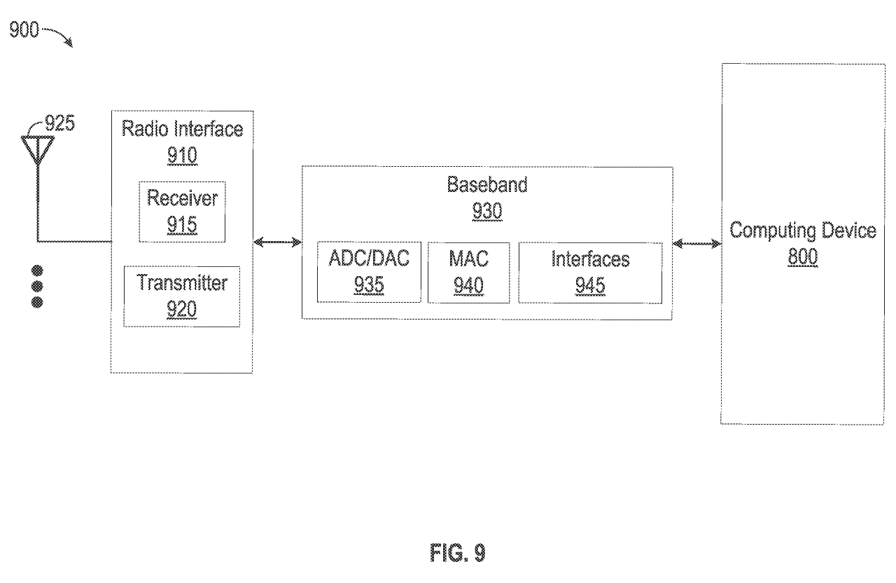

The elements described above of the operating environment 100 (e.g., the controller 105, the first AP 115, the second AP 120, the third AP 125, the first client device 130, the second client device 135, the third client device 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 8 and 9, the elements of the operating environment 100 may be practiced in a computing device 800 and/or communications device 900.

### Resetting DBE at the Same Time or Before Channel Switching

FIG. 2 illustrates a timing graph 200 of an AP resetting DBE at the same time or before channel switching. The y-axis of timing graph 200 indicates the BW of a BSS provided by an AP while the x-axis indicates time. The BW of the BSS is expressed as a channel width (e.g., 40 MHz, 80 MHz, 160 MHz, 320 MHz, etc.). When deployed in an enterprise at Time A, RRM logic or some other resource management scheme (e.g., implemented by a resource manager at controller 105, the APs, and/or other network systems) can be used to assign a baseline BSS BW to the AP. In the illustrated embodiment, 40 MHz is the default operating BW of the BSS which is used by the AP and STAs in the BSS.

At Time B, the AP determines to expand the BW to be used for STAs that can support expanded DBE BW operation. For example, the resource manager utilizing RRM logic (or the AP itself) may identify an increased load at the AP (e.g., more STAs have associated with the AP or the STAs have increased BW needs), determine to expand the BW based on reduced co-channel interference from neighboring APs when neighboring APs are lightly loaded, and/or the like. While expanding the BW can cause neighboring APs in the deployment to potentially have overlapping subchannels which can reduce WLAN stability, the DBE BW expansion can be temporary in order to respond to increased loads that can also be temporary.

Starting at Time C, the AP sends out one or more frames (DBE announcements) to inform the STAs of an upcoming expanded BW DBE operation. The announcement informs the STAs that the expanded DBE BW is being increased (e.g., being expanded from 40 MHz to 160 MHz BW), the channel center frequency for the DBE BW, any punctured subchannels within the DBE BW, a DBE BW switch time/start time when the expansion will take effect, duration for how long DBE expanded BW operation will last, or the like. Announcing the DBE in advance provides time for the STAs to re-calibrate their hardware for operating at the new BW.

At Time D, the DBE BW expansion occurs at the DBE BW switch time indicated in the announcement. As illustrated in FIG. 2, the BW of the AP increases to 160 MHz (from 40 MHz) for this instance of DBE BW expansion. In some embodiments, different STAs may support different capabilities for maximum DBE BW that is supported by the AP. FIG. 2 illustrates that some STAs may utilize less than the maximum DBE dynamic BW (e.g., because they support smaller maximum DBE BW capability). For example, STAs A, B, and C may only be capable of using 80 MHz channel BW. Nonetheless, FIG. 2 illustrates the embodiments herein permit STAs to access the increased/expanded BW, even if they cannot utilize subchannels on the entire expanded BW. In contrast, STAs X, Y, and Z can utilize the entire DBE BW during the expanded BW operation.

Starting at Time E, the AP determines to switch channels and transmits a DBE announcement indicating that the DBE mode/session is going to be terminated or end at Time F. In some embodiments, the AP determines to switch channels at some time before Time E and then transmits the DBE announcement at Time E.

The AP can continue to use the expanded BW until Time F. The announcement sent at Time E (e.g., a termination or reset announcement) indicates when the active DBE mode/session will terminate by indicating a DBE BW switch time when DBE mode will terminate. This DBE announcement can indicate the termination of DBE mode using an explicit “DBE termination” field or it can indicate DBE termination by setting DBE BW parameters to indicate baseline BSS BW parameters (in this case 40 MHz, which signals to STAs that DBE BW is being reset to the baseline BW). In either case, this DBE announcement gives the STAs enough time to prepare (e.g., recalibrate their hardware) to return to the default operating BW of the BSS at the DBE BW switch time indicated.

The AP can announce the DBE reset as shown in FIG. 2 when the channel switch is not critically urgent. For example, if there is sufficient lead time before the channel switch, such as a minimum number of beacon intervals (e.g., between six and twenty beacon intervals, corresponding to approximately 0.6-2 seconds given that beacon intervals are around 0.1 seconds), the AP can determine to announce the DBE reset, reset DBE at the indicated time, and then perform the channel switch. The DBE announcement can be advertised for the full period until the DBE reset (e.g., 0.6-2 seconds), so most or all client devices, even those in deep sleep modes, are expected to receive the DBE announcement before the channel switch. This more structured cleanup approach allows the AP to terminate DBE operation and ensure all STAs are operating on the baseline BW before switching to the new channel.

At Time F, the AP ceases using the expanded BW and returns to the default BW of the BSS (e.g., 40 MHz). After Time F, the AP and the STAs operate with the baseline BW. At Time G, after resetting DBE operation, the AP performs the channel switch to the new channel. The channel switch may occur shortly after Time F, simultaneously with Time F, or well after Time F depending on the implementation. Because the DBE session has been terminated and all STAs are operating on the baseline BW, the channel switch only applies to the baseline BW, which simplifies the transition. After the channel switch completes, the AP may subsequently re-enable DBE operation on the new channel if conditions warrant (e.g., if the AP continues to experience high load and neighboring APs on the new channel are lightly loaded).

### Continuing DBE During Channel Switching

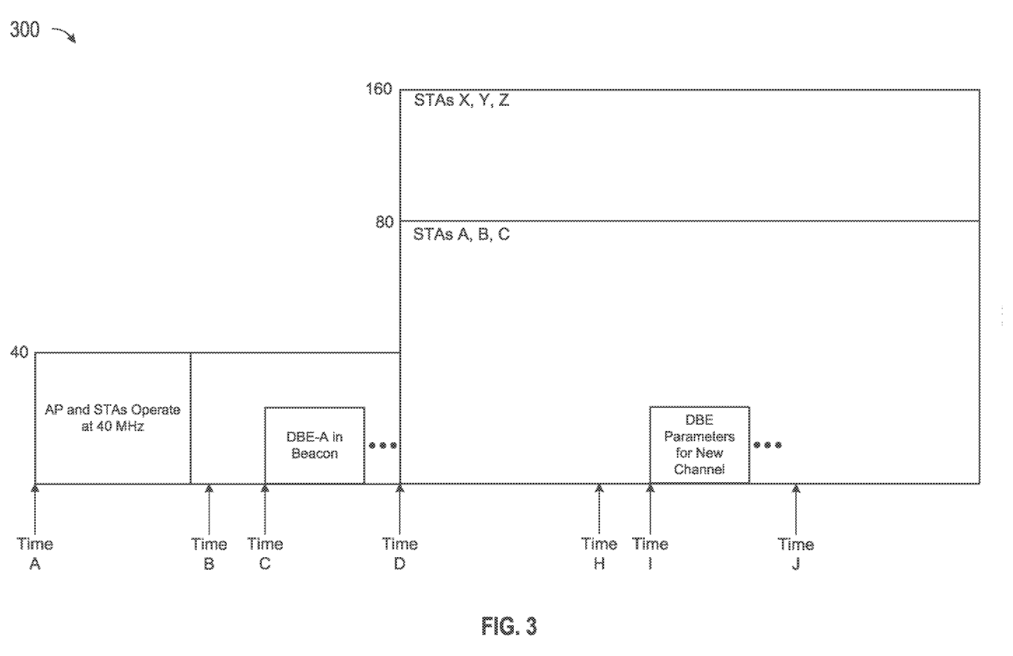

FIG. 3 illustrates a timing graph 300 of an AP continuing DBE during channel switching. Similar to timing graph 200, the AP and STAs begin operating at 40 MHz at Time A, the AP determines to expand the BW at Time B, the AP sends DBE announcements starting at Time C, and the DBE BW expansion occurs at Time D, expanding the operating BW to 160 MHz in the illustrated example.

At Time H, the AP determines to switch channels without terminating DBE operation. Thus, the AP can continue DBE operation to the new channel. This approach can be utilized for both critically urgent channel switches (e.g., DFS incumbent detection requiring rapid channel vacation) and non-urgent channel switches (e.g., RRM-driven optimization). Therefore, this approach can be used whenever the AP determines to preserve DBE operation across a channel switch regardless of urgency.

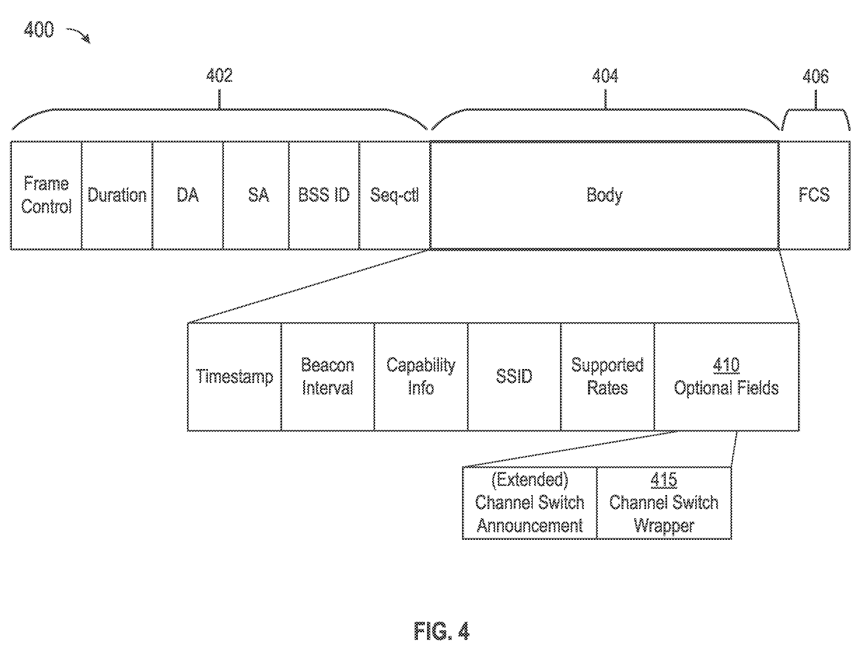

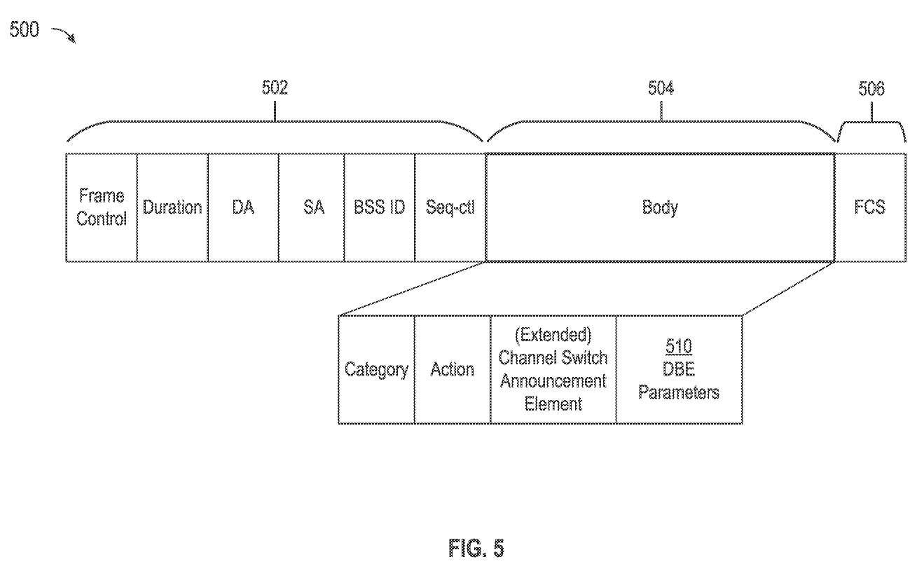

Starting at Time I, the AP sends DBE parameters for the new channel to the STAs. As shown in FIG. 4, elements related to DBE can be transmitted inside a Channel Switch Wrapper element in Beacon frames. Alternatively, as shown in FIG. 5, the DBE-related elements can be transmitted in a Channel Switch Announcement frame and/or an Extended Channel Switch Announcement frame. The DBE parameters encapsulated or transmitted in these frames indicate the DBE BW to be used on the new channel and indicate that the DBE parameters will apply as soon as the channel switch occurs.

In some embodiments, the expanded DBE BW must be unchanged during the channel switch. For example, if the AP is operating with a 40 MHz baseline BW expanded to 160 MHz DBE BW before the switch, the AP will continue operating with 40 MHz baseline BW expanded to 160 MHz DBE BW after the switch. This variant may be required for reduced complexity. In other embodiments, the protocol allows the DBE BW to be enlarged or reduced at the same time as the channel switching. For example, the AP might transition from 40 MHz baseline BW with 160 MHz DBE BW to 40 MHz baseline BW with 320 MHz DBE BW or some other BW on the new channel. This variant provides more generality and flexibility to adapt the DBE BW based on the characteristics of the new channel.

In addition to the DBE BW parameters, the AP may signal a disabled subchannel bitmap (or DBE disabled subchannel bitmap) for the new channel. This bitmap indicates a set of punctured subchannels within the DBE BW on the new channel, which can be different from the punctured subchannels (if any) on the current channel. This allows the AP to adapt to the spectral conditions and interference environment of the new channel.

Multiple beacons and/or other frames can be sent starting at Time I indicating the DBE parameters for the new channel. However, especially for critically urgent channel switches, the number of beacons and/or other frames announcing the DBE parameters for the channel switch may be limited (e.g., fewer than the six to twenty beacon intervals used for non-urgent scenarios), and not all client devices may receive the information before the channel switch occurs. For client devices that miss reception of the DBE parameters, these client devices are configured to wake up and, in response to not detecting beacons on the original channel, scan to find the AP and resume connectivity with the AP on the new channel. When a client device resumes connectivity after missing the channel switch announcement, the client device will need to re-learn the DBE parameters (e.g., whether DBE is off, same, widened, or narrowed relative to the previous channel), including any regulatory information for the new channel such as transmit power envelope (TPE) information or next generation TPE information. In embodiments where it is required, the client must obtain this regulatory information before using the DBE feature on the new channel.

At Time J, the AP switches to the new channel and continues DBE operation according to the DBE parameters signaled at Time I. In the illustrated embodiment of FIG. 3, the DBE BW is unchanged, maintaining 160 MHz DBE BW on the new channel.

FIG. 4 illustrates a beacon frame 400 for signaling continuing DBE operation after channel switching. The beacon frame 400 includes a header 402, a body 404, and a trailer 406. The header 402 comprises a Media Access Control (MAC) header in example implementations. The trailer 406 comprises a frame check sequence (FCS) in example implementations.

The body 404 includes, among other fields, optional fields 410. In the illustrated embodiment, the optional fields 410 include a channel switch wrapper element 415. The channel switch wrapper element 415 contains subelements that indicate characteristics of the BSS after a channel switch. The AP switching channels can indicate the DBE parameters on the new channel using the channel switch wrapper element 415. The DBE parameters encapsulated within the channel switch wrapper element 415 may include the DBE BW for the new channel, channel center frequency information, and the disabled subchannel bitmap indicating punctured subchannels within the DBE BW on the new channel. In example implementations, the channel switch wrapper element 415 is optionally present if “dot11VHTOptionImplemented” is true and at least one of a channel switch announcement element or an extended channel switch announcement element is also present in the beacon frame 400, and the channel switch wrapper element 415 contains at least one subelement. In some embodiments, a new wrapper element may be defined specifically for encapsulating DBE parameters for the new channel.

FIG. 5 illustrates an example channel switch announcement frame 500 for signaling continuing DBE operation after channel switching. The frame 500 is a Channel Switch Announcement frame in some embodiments and an Extended Channel Switch Announcement frame in other embodiments. The frame 500 includes a header 502, a body 504, and a trailer 506. The header 502 comprises a MAC header in example implementations, and the trailer 506 comprises an FCS in example implementations. The body 504 of the frame 500 includes a category field, an action field, a channel switch announcement element (or an extended channel switch announcement element depending on whether the frame 500 is an Extended Channel Switch Announcement frame), and a DBE parameters field 510. The AP switching channels can indicate the DBE parameters on the new channel using the DBE parameters field 510 transmitted directly in the frame 500. The DBE parameters field 510 may include the DBE BW for the new channel, channel center frequency information, and the disabled subchannel bitmap indicating punctured subchannels within the DBE BW on the new channel.

Therefore, APs can utilize beacon frames 400 with a channel switch wrapper element 415 and Channel Switch Announcement frames (including Extended Channel Switch Announcement frames) 500 with a DBE parameters field 510 to communicate DBE parameters to continue DBE operation when switching channels. These signaling mechanisms enable the AP to preserve and potentially refine the DBE session across a channel switch, thereby maintaining the benefits of expanded BW operation while transitioning to a new operating channel. Other frames and signaling mechanisms can be utilized in further embodiments.

### “Silently” Resetting DBE During Channel Switching

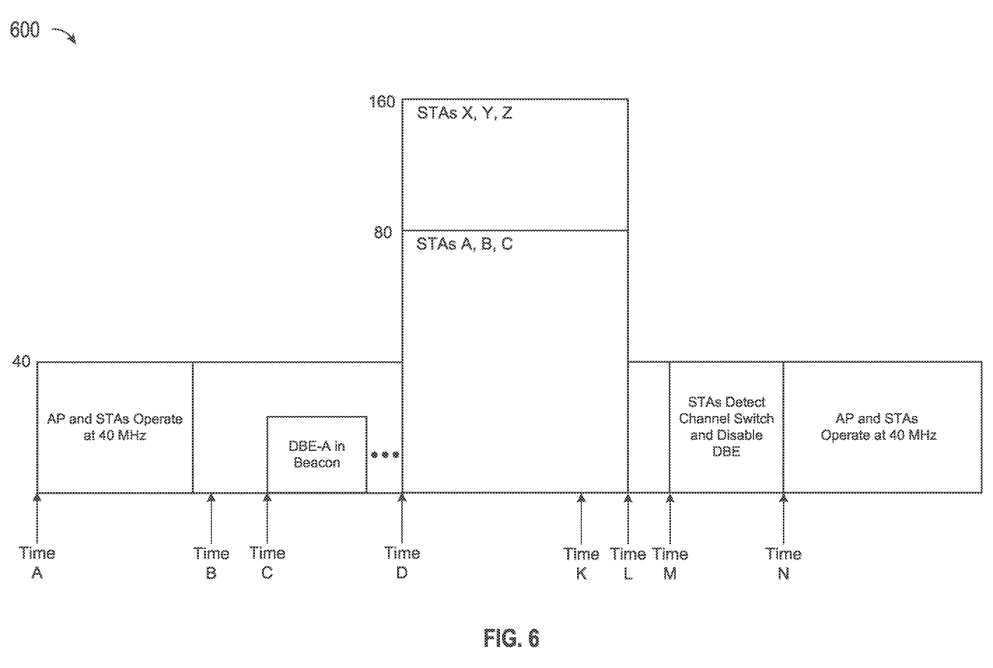

FIG. 6 illustrates a timing graph 600 of an AP resetting DBE without signaling a switch during channel switching. Similar to timing graph 200 and timing graph 300, the AP and STAs begin operating at 40 MHz at Time A, the AP determines to expand the BW at Time B, the AP sends DBE announcements starting at Time C, and the DBE BW expansion occurs at Time D, expanding the operating BW to 160 MHz in the illustrated example.

At Time K, the AP determines to switch channels. In this embodiment, the AP does not to transmit information to the STAs regarding the DBE status after the channel switch, either because of the urgency required for the channel switch, because the AP is overloaded and must switch channels and reset DBE without signaling, or because the AP is otherwise configured to “silently” reset DBE when switching channels pursuant to a defined rule. In contrast timing graph 200, where the AP explicitly announces DBE termination before the channel switch, and timing graph 300, where the AP signals continuing or modified DBE parameters for the new channel, Silently resetting DBE in timing graph 600 relies on a predefined standard rule and requires no new signaling in example embodiments. In these embodiments, the APs and STAs understand that a channel switch indicates to terminate DBE operation and operate at the baseline BW.

At Time L, the AP resets DBE and operates at 40 MHz. At Time M, the AP switches channels. In certain embodiments, Time L and Time M occur simultaneously or nearly simultaneously. For example, the channel switch event can indicate to reset DBE.

Between Time M and Time N, the STAs detect the channel switch and automatically disable DBE, for example based on a defined rule. After Time N, the AP and STAs operate at 40 MHz on the new channel. The AP can perform a subsequent DBE BW expansion after switching the channel using existing DBE establishment mechanisms.

The IEEE 802.11bn standard and/or amendments may define a rule requiring that a DBE session is automatically (and silently) torn down whenever the AP performs a channel switch. This provides simplicity because when switching to a new channel. For instance, the same DBE BW may not be possible due to the different channel location and spectral characteristics of the new channel. In certain implementations, the DBE session is required to be torn down only for a primary channel change. If the BW changes but the primary channel remains unchanged, the DBE session is not torn down. In other implementations, the DBE session is required to be torn down for either a primary channel change or a BW change (e.g., to adjust from 160 MHz to 320 MHz, the AP must return to 40 MHz in between). Client devices are configured to automatically disable DBE whenever they detect that their associated AP has performed an affected channel switch according to the defined rule.

### Signaled Policy for DBE Session Management

In some embodiments, an AP can advertise a policy to indicate how DBE sessions are managed during channel switches. The policy can be signaled via a one-bit field in the UHR Operations element, DBE element, or similar information element. In example implementations, the policy indicates whether all DBE sessions are automatically and silently torn down whenever the AP performs a channel switch or whether DBE sessions are preserved across channel switches. In other implementations, the policy indicates whether all DBE sessions are torn down whenever the AP performs a channel switch (e.g., as illustrated in FIG. 2), preserved (e.g., as shown in FIG. 3), or silently torn down whenever the AP performs a channel switch (e.g., as shown in FIG. 6). Thus, the AP can select how it will manage DBE during channel switching. If the policy indicates that DBE sessions are preserved, the AP is still responsible for providing new regulatory information for the new DBE channel, such as TPE information or next generation TPE information. If required, the client devices must obtain this regulatory information before using the DBE feature on the new channel.

### Rules for Edge-of-Band Primary Channels

Some primary channels, typically at the edge of bands, cannot be part of wide BSS or DBE BWs. For example, channel 169 at 5 GHz and the uppermost 2×20/40 MHz 6 GHz channels in the United States have constraints on the maximum BW that can be supported. If an AP with a wide DBE BW performs a channel switch to one of these constrained primary channels, the wide DBE BW may not be feasible on the new channel.

A rule may be defined in the IEEE 802.11bn standard and/or amendments or elsewhere to handle this situation. If a wide DBE BW is not allowed at the new primary channel, then the rule may specify that either: the DBE session is automatically torn down, returning the AP and STAs to the baseline BW; or the DBE BW is automatically lowered to the maximum allowed BW for the new channel (e.g., 40 MHz for the uppermost 6 GHz channels, or 160 MHz for other constrained channels). The auto-lowering option may consider the relative position of the available BW, potentially excluding certain 320 MHz expansions if their relative position differs from the previous channel.

### Signaled Behavior for Edge-of-Band Channels

In some embodiments, the AP signals the specific behavior rather than relying solely on a standard-defined rule. The AP signals, either up front (e.g., at DBE session establishment) or along with the channel switch countdown, how the DBE session will be managed when switching to a constrained channel. The signaling indicates whether: the DBE session is automatically torn down, the DBE BW is automatically lowered to the allowed BW, or, to allow for regulatory changes, the AP specifies what the new DBE BW will be.

The embodiments disclosed herein provide flexibility for managing DBE operation during channel switching across a range of scenarios, from critically urgent channel switches requiring rapid action to non-urgent switches allowing graceful transitions. The selection among embodiments may depend on factors such as the urgency of the channel switch, the characteristics and regulatory constraints of the target channel, the complexity requirements of the implementation, and the desired balance between backward compatibility and performance optimization.

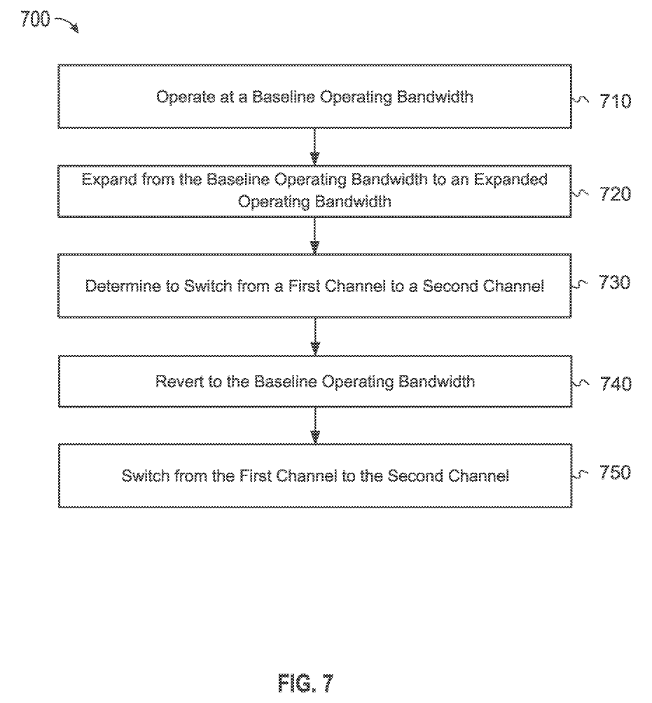

FIG. 7 illustrates a method 700 for managing bandwidth operation during channel switching. The method 700 is performed by an AP in example implementations.

At stage 710, the AP operates at a baseline operating bandwidth. The baseline operating bandwidth comprises a BSS bandwidth in example implementations. For example, the AP may operate at 40 MHz, 80 MHz, or another baseline bandwidth.

At stage 720, the AP expands from the baseline operating bandwidth to an expanded operating bandwidth for a client device associated with the AP. The expanded operating bandwidth comprises a DBE bandwidth in example implementations. For example, the AP may expand from 40 MHz to 160 MHz or 320 MHz. The expanded operating bandwidth is utilized by one or more client devices that support expanded bandwidth operation (e.g., UHR STAs or Wi-Fi 8 clients).

At stage 730, the AP determines to switch from a first channel to a second channel. The determination to switch channels may be triggered by various events, including detecting an incumbent user on the first channel (e.g., radar detection in 5 GHz DFS spectrum), receiving updated power allocation information from an AFC database indicating reduced transmit power on the first channel, detecting persistent interference on the first channel (e.g., unlicensed cellular systems or other interfering transmitters), or determining to optimize radio resource management based on interference conditions. In some embodiments, the determination to switch channels includes determining that the second channel has a bandwidth constraint that prevents use of a wide expanded operating bandwidth. The bandwidth constraint may arise because the second channel is at an edge of a frequency band where wide bandwidths are not permitted.

At stage 740, in response to the determining, the AP reverts to the baseline operating bandwidth. In some embodiments, the AP reverts to the baseline operating bandwidth based on a defined rule that specifies expanded bandwidth operation is automatically terminated when the AP performs a channel switch. The defined rule may specify that expanded bandwidth operation is automatically terminated in response to a primary channel change or in response to either a primary channel change or a BSS bandwidth change. In some embodiments, reverting to the baseline operating bandwidth is based on the second channel having a bandwidth constraint, such as an edge-of-band constraint that prevents wide expanded bandwidth operation.

In some embodiments, the AP transmits, to the client device, one or more announcements indicating that the AP will revert to the baseline operating bandwidth for the client device to operate at the baseline operating bandwidth before the AP switches from the first channel to the second channel. The one or more announcements may be transmitted for a minimum number of beacon intervals to provide sufficient time for client devices, including those in deep sleep modes, to receive the announcements. The announcements may indicate when the expanded bandwidth operation will terminate by specifying a bandwidth switch time. In some embodiments, the announcements may be pre-existing and/or have been previously transmitted (e.g., for switching channels) and may also apply to the change or reset of the DBE bandwidth.

At stage 750, in response to the determining, the AP switches from the first channel to the second channel. After switching to the second channel, the AP operates at the baseline operating bandwidth or again expands to an expanded operating bandwidth. In some embodiments, stage 740 and stage 750 occur simultaneously or nearly simultaneously (e.g., within 0.1 milliseconds). Thus, the AP can revert to the baseline operating bandwidth while switching to the new channel.

In some embodiments, the method 700 further comprises re-establishing, by the AP, a connection with the client device after switching to the second channel, and providing, by the AP to the client device, bandwidth parameters indicating a present operating bandwidth. This allows client devices that missed announcements about the channel switch to rejoin the AP and learn the current bandwidth parameters.

In some embodiments, the method 700 further comprises advertising, by the AP to the client device, a policy indicating whether any expanded bandwidth is automatically reverted to the baseline operating bandwidth or preserved during channel switching. In some embodiments, the method 700 further comprises expanding, by the AP, from the baseline operating bandwidth to a second expanded operating bandwidth on the second channel, determining, by the AP, to switch from the second channel to a third channel, and in response to the determining, transmitting, by the AP to the client device, bandwidth parameters to use for the third channel, and switching, by the AP, from the second channel to the third channel. The bandwidth parameters for the third channel may indicate an expanded operating bandwidth to be continued on the third channel, which may be the same as or different from the second expanded operating bandwidth. The AP may transmit the bandwidth parameters using any one of: (i) a channel switch wrapper element in a beacon frame, (ii) a channel switch announcement frame, or (iii) an extended channel switch announcement frame.

FIG. 8 is a block diagram of a computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for managing DBE with channel switching. Computing device 800, for example, may provide an operating environment for the controller 105, the first AP 115, the second AP 120, the third AP 125, the first client device 130, the second client device 135, the third client device 140, and the like. The controller 105, the first AP 115, the second AP 120, the third AP 125, the first client device 130, the second client device 135, the third client device 140, and the like may operate in other environments and are not limited to computing device 800.

Computing device 800 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples, and computing device 800 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 800 on the single integrated circuit (chip).

FIG. 9 illustrates an implementation of a communications device 900 that may implement one or more of the controller 105, the first AP 115, the second AP 120, the third AP 125, the first client device 130, the second client device 135, the third client device 140, etc. In various implementations, the communications device 900 may comprise a logic circuit. The logic circuit may include physical circuits to perform operations described for one or more of the controller 105, the first AP 115, the second AP 120, the third AP 125, the first client device 130, the second client device 135, the third client device 140, etc., for example. As shown in FIG. 9, the communications device 900 may include one or more of, but is not limited to, a radio interface 910, baseband circuitry 930, and/or the computing device 800.

The communications device 900 may implement some or all of the structures and/or operations for the controller 105, the first AP 115, the second AP 120, the third AP 125, the first client device 130, the second client device 135, the third client device 140, etc., storage medium, and logic circuit in a single computing entity, such as entirely within a single device. Alternatively, the communications device 900 may distribute portions of the structure and/or operations using a distributed system architecture, such as a client station server architecture, a peer-to-peer architecture, a master-slave architecture, etc.

A radio interface 910, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 910 may include, for example, a receiver 915 and/or a transmitter 920. The radio interface 910 may include bias controls, a crystal oscillator, and/or one or more antennas 925. In additional or alternative configurations, the radio interface 910 may use oscillators and/or one or more filters, as desired.

The baseband circuitry 930 may communicate with the radio interface 910 to process, receive, and/or transmit signals and may include, for example, an Analog-To-Digital Converter (ADC) for down converting received signals with a Digital-To-Analog Converter (DAC) 935 for up converting signals for transmission. Further, the baseband circuitry 930 may include a baseband or Physical (PHY) layer processing circuit for the PHY link layer processing of respective receive/transmit signals. Baseband circuitry 930 may include, for example, a MAC processing circuit 940 for MAC/data link layer processing. Baseband circuitry 930 may include a memory controller for communicating with MAC processing circuit 940 and/or a computing device 800, for example, via one or more interfaces 945.

In some configurations, PHY processing circuit may include a frame construction and/or detection module, in combination with additional circuitry such as a buffer memory, to construct and/or deconstruct communication frames. Alternatively or in addition, MAC processing circuit 940 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising
maintaining, by a wireless station, a connection to a Basic Service Set (BSS) implemented by an access point;
wherein the access point is configured to support the BSS on a first BSS primary channel within an allocated band and, in a baseline BSS bandwidth mode of operation, at a baseline BSS bandwidth and, in a dynamic bandwidth expansion (DBE) mode of operation, at a DBE bandwidth,
wherein the DBE bandwidth is greater than the baseline BSS bandwidth;
receiving, by the wireless station, one or more messages from the access point, the one or more messages announcing enablement of the DBE mode of operation;
responsive to enablement of the DBE mode of operation, enabling, by the wireless station, the DBE mode of operation;
receiving, by the wireless station, a channel switch announcement from the access point, the channel switch announcement indicating a second primary BSS channel;
responsive to the channel switch announcement, automatically disabling, by the wireless station, the DBE mode of operation; and
switching, by the wireless station, to the second primary BSS channel.

2. The method of claim 1 wherein disabling the DBE mode of operation is performed by the wireless station without any DBE signaling transmitted by the access point.

3. The method of claim 1 further comprising receiving, by the wireless station, one or more messages from the access point, the one or more messages announcing a change to one or more parameters of the DBE mode of operation.

4. The method of claim 1 wherein the one or more messages announcing enablement of the DBE mode of operation include information indicating one or more of a start time for the DBE mode of operation, a center channel frequency of the DBE mode of operation, a duration of the DBE mode of operation, the DBE bandwidth, and one or more punctured subchannels within the DBE bandwidth.

5. The method of claim 4 wherein the one or more messages are received before the start time of the DBE mode of operation.

6. The method of claim 1 wherein the one or more messages announcing enablement of the DBE mode of operation are wireless beacon frames.

7. The method of claim 1 wherein the one or more messages announcing enablement of the DBE mode of operation are probe response or association response frames.

8. A wireless station comprising
a processor; and
a memory communicatively coupled to the processor, wherein the memory comprises instructions configured to cause the wireless station to perform operations comprising:
maintaining, by the wireless station, a connection to a Basic Service Set (BSS) implemented by an access point;
wherein the access point is configured to support the BSS on a first BSS primary channel within an allocated band and, in a baseline BSS bandwidth mode of operation, at a baseline BSS bandwidth and, in a dynamic bandwidth expansion (DBE) mode of operation, at a DBE bandwidth,
wherein the DBE bandwidth is greater than the baseline BSS bandwidth;
receiving, by the wireless station, one or more messages from the access point, the one or more messages announcing enablement of the DBE mode of operation;
responsive to enablement of the DBE mode of operation, enabling, by the wireless station, the DBE mode of operation;
receiving, by the wireless station, a channel switch announcement from the access point, the channel switch announcement indicating a second primary BSS channel;
responsive to the channel switch announcement, automatically disabling, by the wireless station, the DBE mode of operation; and
switching, by the wireless station, to the second primary BSS channel.

9. The wireless station of claim 8 wherein disabling the DBE mode of operation is performed by the wireless station without any DBE signaling transmitted by the access point.

10. The wireless station of claim 8, the operations further comprising receiving, by the wireless station, one or more messages from the access point, the one or more messages announcing a change to one or more parameters of the DBE mode of operation.

11. The wireless station of claim 8 wherein the one or more messages announcing enablement of the DBE mode of operation include information indicating one or more of a start time for the DBE mode of operation, a center channel frequency of the DBE mode of operation, a duration of the DBE mode of operation, the DBE bandwidth, and one or more punctured subchannels within the DBE bandwidth.

12. The wireless station of claim 11 wherein the one or more messages are received before the start time of the DBE mode of operation.

13. The wireless station of claim 8 wherein the one or more messages announcing enablement of the DBE mode of operation are wireless beacon frames.

14. The wireless station of claim 8 wherein the one or more messages announcing enablement of the DBE mode of operation are probe response or association response frames.

15. A non-transitory computer readable storage medium comprising instructions that when executed configure one or more processors of a wireless station to perform operations comprising:
maintaining, by the wireless station, a connection to a Basic Service Set (BSS) implemented by an access point;
wherein the access point is configured to support the BSS on a first BSS primary channel within an allocated band and, in a baseline BSS bandwidth mode of operation, at a baseline BSS bandwidth and, in a dynamic bandwidth expansion (DBE) mode of operation, at a DBE bandwidth,
wherein the DBE bandwidth is greater than the baseline BSS bandwidth;
receiving, by the wireless station, one or more messages from the access point, the one or more messages announcing enablement of the DBE mode of operation;
responsive to enablement of the DBE mode of operation, enabling, by the wireless station, the DBE mode of operation;
receiving, by the wireless station, a channel switch announcement from the access point, the channel switch announcement indicating a second primary BSS channel;
responsive to the channel switch announcement, automatically disabling, by the wireless station, the DBE mode of operation; and
switching, by the wireless station, to the second primary BSS channel.

16. The non-transitory computer readable storage medium of claim 15 wherein disabling the DBE mode of operation is performed by the wireless station without any DBE signaling transmitted by the access point.

17. The non-transitory computer readable storage medium of claim 15, the operations further comprising receiving, by the wireless station, one or more messages from the access point, the one or more messages announcing a change to one or more parameters of the DBE mode of operation.

18. The non-transitory computer readable storage medium of claim 15 wherein the one or more messages announcing enablement of the DBE mode of operation include information indicating one or more of a start time for the DBE mode of operation, a center channel frequency of the DBE mode of operation, a duration of the DBE mode of operation, the DBE bandwidth, and one or more punctured subchannels within the DBE bandwidth.

19. The non-transitory computer readable storage medium of claim 18 wherein the one or more messages are received before the start time of the DBE mode of operation.

20. The non-transitory computer readable storage medium of claim 15 wherein the one or more messages announcing enablement of the DBE mode of operation are wireless beacon frames.

21. The non-transitory computer readable storage medium of claim 15 wherein the one or more messages announcing enablement of the DBE mode of operation are probe response or association response frames.
